(19) United States
(12) Patent Application Publication
(10) Pub. No.: US 2016/0118043 A1
(43) Pub. Date: Apr. 28, 2016

(54) ELECTRONIC DEVICE AND ALARM CONTROL METHOD OF THE ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: YONG-ZHAO HUANG, Wuhan (CN)

(21) Appl. No.: 14/692,284

(22) Filed: Apr. 21, 2015

(30) Foreign Application Priority Data
Oct. 27, 2014 (CN) 201410580931.3

(51) Int. Cl. G10L 15/22

(52) U.S. Cl. CPC G10L 15/22; G10L 2015/223

(57) ABSTRACT

In an alarm control method executed in an electronic device, voice commands are set using a voice capturing device and stored into a storage device. The voice commands are set for controlling an alarm of the electronic device. In event the alarm rings, real-time audio data is captured using the voice capturing device. The voice commands are read from the storage device, and the voice commands are compared with the audio data to determine that at least one voice command matches the audio data. The alarm is controlled according to a matched voice command.

### CROSS-REFERENCE TO RELATED APPLICATIONS

This application claims priority to Chinese Patent Application No. 201410580931.3 filed on Oct. 27, 2014, the contents of which are incorporated by reference herein.

### FIELD

The subject matter herein generally relates to control technology, and particularly to an electronic device and an alarm control method of the electronic device.

### BACKGROUND

A user may set an alarm clock or a timer to set off an alarm using an electronic device (e.g., a mobile phone). When the alarm rings, it may be inconvenient for the user to turn off the alarm or decrease a volume of the alarm.

### BRIEF DESCRIPTION OF THE DRAWINGS

Implementations of the present technology will now be described, by way of example only, with reference to the attached figures.

FIG. 1 is a block diagram of one example embodiment of a hardware environment for executing an alarm control system.

FIG. 2 is a block diagram of one example embodiment of function modules of the alarm control system in FIG. 1.

FIG. 3 is a flowchart of one example embodiment of an alarm control method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

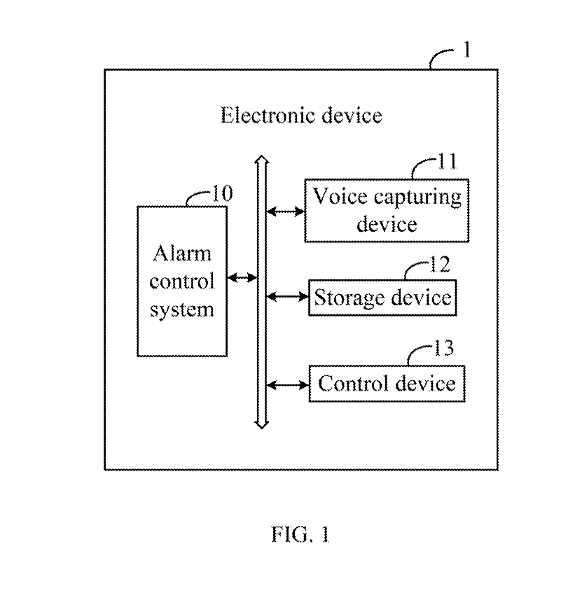

FIG. 1 is a block diagram of one example embodiment of a hardware environment for executing an alarm control system 10. The alarm control system 10 is installed in and run by an electronic device 1. The electronic device 1 can include a voice capturing device 11, a storage device 12, and at least one control device 13.

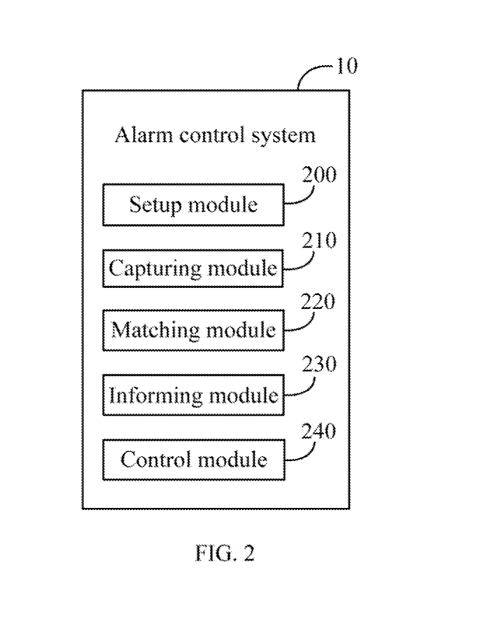

The alarm control system 10 can include a plurality of function modules (shown in FIG. 2) that control an alarm of the electronic device 1.

The voice capturing device 11 is configured to capture a voice of a user.

The storage device 12 can include some type(s) of non-transitory computer-readable storage medium such as, for example, a hard disk drive, a compact disc, a digital video disc, or a tape drive. The storage device 12 stores the computerized codes of the function modules of the alarm control system 10.

The control device 13 can be a processor, an application-specific integrated circuit (ASIC), or a field programmable gate array (FPGA), for example. The control device 13 can execute computerized codes of the function modules of the alarm control system 10 to realize the functions of the electronic device 1.

FIG. 2 is a block diagram of one embodiment of function modules of the alarm control system 10. The function modules can include, but are not limited to, a setup module 200, a capturing module 210, a matching module 220, an informing module 230, and a control module 240. The function modules 200-240 can include computerized codes in the form of one or more programs, which provide at least the functions of the alarm control system 10.

The setup module 200 is configured to set voice commands of a user of the electronic device 1 for controlling an alarm of the electronic device 1 using the voice capturing device 11, and stores the voice commands into the storage device 12. In one embodiment, the setup module 200 can determine whether a predetermined condition for voice command setup is met. If the predetermined condition for voice command setup is met, the setup module 200 captures voice samples of the user using the voice capturing device 11, and stores the voice samples into the storage device 12 as the voice commands. For example, if a predetermined button for voice command setup is pressed, the setup module 200 captures the voice samples of the user using the voice capturing device 11, and stores the voice samples into the storage device 12 as the voice commands. The voice commands can be stored in a voice database of the storage device 12. The voice commands can include commands of decreasing a volume of the alarm, turning off the alarm, and/or delaying the alarm.

The capturing module 210 is configured to capture real-time audio data of the user using the voice capturing device 11 in event the alarm rings. In one embodiment, the user sets a timer in the electronic device 1. When the timer times out, the alarm rings.

The matching module 220 is configured to read the voice commands of the user from the storage device 12, and determine whether any of the voice commands matches the audio data by comparing the voice commands with the audio data. In one embodiment, the matching module 220 calculates a similarity of each voice command to the audio data, and determines whether the voice command matches the audio data according to the similarity. For example, if the similarity of a voice command to the audio data is greater than a predetermined value (e.g., 0.9), the voice command is determined to match the audio data. A similarity of a voice command to the audio data indicates a similar degree between the voice command and the audio data.

The informing module 230 is configured to inform the user of an alarm control failure if none of the voice commands matches the audio data. For example, the informing module 230 issues a voice message “Your command does not match. Please reenter the voice command.”

The control module 240 is configured to control the alarm if at least one voice command matches the audio data. The voice commands can include decreasing the volume of the alarm, turning off the alarm, and/or delaying the alarm. Accordingly, the control module 240 can decrease the volume of the alarm, turn off the alarm, or delay the alarm.

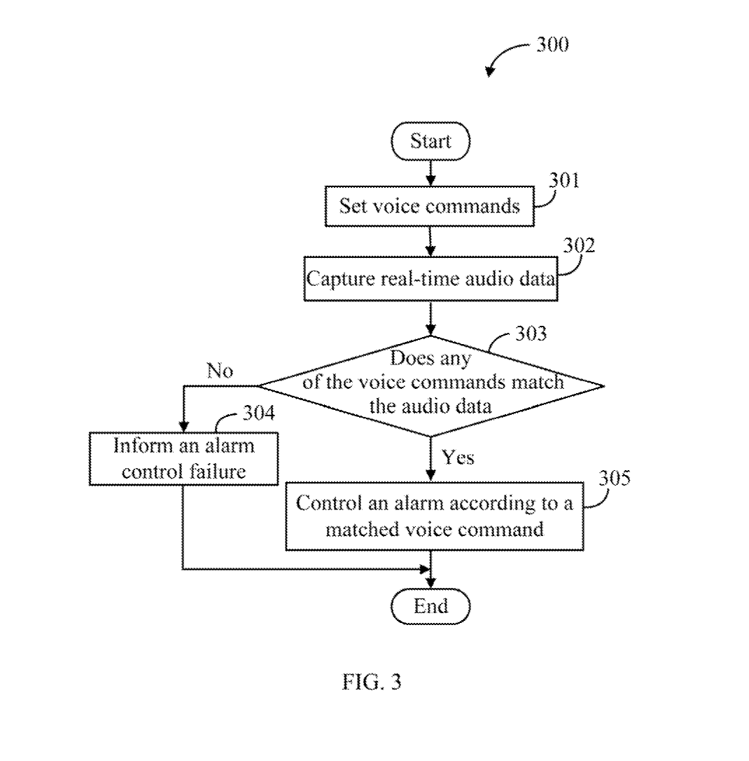

FIG. 3 is a flowchart of one example embodiment of an alarm control method. In the embodiment, the method is performed by execution of computer-readable software program codes or instructions by a control device, such as at least one processor of an electronic device. The electronic device includes a voice capturing device.

Referring to FIG. 3, a flowchart is presented in accordance with an example embodiment. The method 300 is provided by way of example, as there are a variety of ways to carry out the method. The method 300 described below can be carried out using the configurations illustrated in FIGS. 1-2, for example, and various elements of these figures are referenced in explaining method 300. Each block shown in FIG. 3 represents one or more processes, methods, or subroutines, carried out in the method 300. Furthermore, the illustrated order of blocks is illustrative only and the order of the blocks can be changed. Additional blocks can be added or fewer blocks may be utilized without departing from this disclosure. The method 300 can begin at block 301.

At block 301, a setup module sets voice commands of a user of the electronic device for controlling an alarm of the electronic device using the voice capturing device, and stores the voice commands into a storage device. In one embodiment, the setup module can determine whether a predetermined condition for voice command setup is met. If the predetermined condition for voice command setup is met, the setup module captures voice samples of the user using the voice capturing device, and stores the voice samples into the storage device as the voice commands. For example, if a predetermined button for voice command setup is pressed, the setup module captures the voice samples of the user using the voice capturing device, and stores the voice samples into the storage device as the voice commands. The voice commands can be stored in a voice database of the storage device. The voice commands can include decreasing the volume of the alarm, turning off the alarm, and/or delaying the alarm.

When the alarm rings, at block 302, a capturing module captures real-time audio data of the user using the voice capturing device. The user can set a timer in the electronic device. When the timer times out, the alarm rings.

At block 303, a matching module reads the voice commands of the user from the storage device, and determines whether any of the voice commands matches the audio data by comparing the voice commands with the audio data. In one embodiment, the matching module calculates a similarity of each voice command to the audio data, and determines whether the voice command matches the audio data according to the similarity. For example, if the similarity of a voice command to the audio data is greater than a predetermined value (e.g., 0.9), the voice command is determined matching the audio data. A similarity of a voice command to the audio data indicates a similar degree between the voice command and the audio data.

If none of the voice commands matches the audio data, at block 304, an informing module informs the user of an alarm control failure. For example, the informing module can issue a voice message “Your command does not match. Please reenter the voice command.”

If at least one voice command matches the audio data, at block 305, a control module controls the alarm according to a voice command that matches the audio data. The voice commands can include decreasing the volume of the alarm, turning off the alarm, and/or delaying the alarm. Accordingly, the control module decreases the volume of the alarm, turns off the alarm, or delays the alarm.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An alarm control method for an electronic device, the method comprising:
setting voice commands for controlling an alarm of the electronic device using a voice capturing device, and storing the voice commands into a storage device;
capturing real-time audio data using the voice capturing device in event the alarm rings;
reading the voice commands from the storage device, and determining that at least one voice command matches the audio data by comparing the voice commands with the audio data; and
controlling the alarm according to a matched voice command.

2. The method according to claim 1, further comprising:
informing an alarm control failure upon condition that none of the voice commands matches the audio data.

3. The method according to claim 1, wherein the voice commands comprise decreasing a volume of the alarm, turning off the alarm, and delaying the alarm.

4. The method according to claim 1, wherein the voice samples are captured upon condition that a predetermined condition for voice command setup is met.

5. An electronic device comprising:
a voice capturing device;
a control device; and
a storage device storing one or more programs which when executed by the control device, causes the control device to perform operations comprising:
setting voice commands for controlling an alarm of the electronic device using the voice capturing device, and storing the voice commands into the storage device;
capturing real-time audio data using the voice capturing device in event the alarm rings;
reading the voice commands from the storage device, and determining that at least one voice command matches the audio data by comparing the voice commands with the audio data; and
controlling the alarm according to a matched voice command.

6. The electronic device according to claim 5, wherein the operations further comprise:
informing an alarm control failure upon condition that none of the voice commands matches the audio data.

7. The electronic device according to claim 5, wherein the voice commands comprise decreasing a volume of the alarm, turning off the alarm, and delaying the alarm.

8. The electronic device according to claim 5, wherein the voice samples are captured upon condition that a predetermined condition for voice command setup is met.

9. A non-transitory storage medium having stored thereon instructions that, when executed by a control device of an electronic device, causes the control device to perform an alarm control method, the method comprising:
setting voice commands for controlling an alarm of the electronic device using a voice capturing device, and storing the voice commands into a storage device;
capturing real-time audio data using the voice capturing device in event the alarm rings;
reading the voice commands from the storage device, and determining that at least one voice command matches the audio data by comparing the voice commands with the audio data; and
controlling the alarm according to a matched voice command.

10. The non-transitory storage medium according to claim 9, wherein the method further comprises:
informing an alarm control failure upon condition that none of the voice commands matches the audio data.

11. The non-transitory storage medium according to claim 9, wherein the voice commands comprise decreasing a volume of the alarm, turning off the alarm, and delaying the alarm.

12. The non-transitory storage medium according to claim 9, wherein the voice samples are captured upon condition that a predetermined condition for voice command setup is met.
